(19) United States
(12) Patent Application Publication
(10) Pub. No.: US 2022/0268388 A1
(43) Pub. Date: Aug. 25, 2022

(54) SPACER FOR ADJUSTING THE POSITION OF A REHABILITATION PIPE AND POSITION ADJUSTING METHOD USING SUCH

(71) Applicant: Shonan Gosei-Jushi Seisakusho K.K., Hiratsuka-shi (JP)

(72) Inventor: Takao KAMIYAMA, Hiratsuka-shi (JP)

(21) Appl. No.: 17/668,589

(22) Filed: Feb. 10, 2022

(30) Foreign Application Priority Data
Feb. 25, 2021 (JP) 2021-029128

(51) Int. Cl. F16L 55/165

(52) U.S. Cl. CPC F16L 55/1657

(57) ABSTRACT

A spacer is inserted into a gap between an existing pipe and a rehabilitation pipe to adjust the position of the rehabilitation pipe inside the existing pipe. The spacer comprises a first wedge-shaped member with teeth formed at a predetermined pitch and a second wedge-shaped member having an elastic deformable member. The elastic deformable member is provided with teeth that engage with the teeth of the first wedge-shaped member so that the second wedge-shaped member can move relative to the first wedge-shaped member in the insertion direction and cannot be moved in the opposite direction. The second wedge-shaped member is provided with a filler passage hole for passing therethrough a filler injected into the gap between the existing pipe and the rehabilitation pipe. The elastic deformable member is elastically deformed into the filler passage hole to disengage the teeth of the first and second wedge-shaped members to allow movement of the second wedge-shaped member in the direction opposite the insertion direction.

### CROSS-REFERENCE TO RELATED APPLICATIONS

This application claims benefit of Japan Application No. 2021-029128. filed on Feb. 25, 2021, which is herein incorporated by reference in its entirety.

### TECHNICAL FIELD

The present invention relates to a position adjusting spacer that is inserted in a gap between an existing pipe and a rehabilitation pipe to adjust the position of the rehabilitation pipe, and a position adjusting method using such a spacer.

### BACKGROUND ART

A method for repairing or rehabilitating an existing pipe such as a sewer pipe is known in which a habilitation pipe whose outer diameter is slightly smaller than the inner diameter of the existing pipe is laid inside the existing pipe and a compound pipe is constructed by injecting a filler into the gap between the outer periphery of the rehabilitation pipe and the inner wall surface of the existing pipe. A work for rehabilitating the existing pipe normally requires the fixing of the rehabilitation pipe by adjusting the position thereof in the upper, lower, left, and right directions inside the existing pipe to a position slightly offset downward from the position concentric with the existing pipe so that the lower end of the outer periphery of the rehabilitation pipe contacts the bottom of the existing pipe.

The purpose of this is to ensure the flow of fluid inside the existing pipe by lowering the bottom of the rehabilitation pipe so that it approaches the bottom of the existing pipe as much as possible and is to thicken and strengthen the filler on the upper side because the majority of damage to existing pipes occurs on the upper side portion thereof. In this connection, the abovementioned position adjustment is needed in order to press the rehabilitation pipe downward because the rehabilitation pipe is made of a plastic material having a specific gravity lower than the filler and it floats above the filler.

To adjust the position of such a rehabilitation pipe, a configuration for adjusting the overall height of the spacer to a predetermined height is known which comprises a first wedge-shaped member that is inclined at a predetermined angle so that the far side in the insertion direction is higher; a second wedge-shaped member that is inclined at the same angle as the inclination angle of the first wedge-shaped member and is overlapped on the first wedge-shaped member so as to align with the inclination angle surface thereof; and a locking means for locking the second wedge-shaped member so that it can be moved relative to the first wedge-shaped member in the insertion direction but cannot be moved in the opposite direction (Patent Document 1 below).

A configuration is further known in which the second wedge-shaped member is provided with an elastic deformable member that can unlock it from the first wedge-shaped member and the elastic deformable member is elastically deformed to unlock both wedge-shaped members in order to allow the second wedge-shaped member to move in the direction opposite the insertion direction (Patent Document 2 below).

### PRIOR ART DOCUMENTS

### Patent Documents

Patent Document 1: JP 2005-265070 A1

Patent Document 2: JP 2016-176571 A1

### SUMMARY OF INVENTION

### Problems to be Solved

In the configuration described in Patent Document 2, the overall height of the spacer can be readjusted by elastically deforming the elastic deformable member and moving the second wedge-shaped member in the opposite direction when it is adjusted to an inappropriate height. However, the elastic deformable member hits the lower surface of the second wedge-shaped member when it is elastically deformed, so that it displaces very few and it is difficult to unlock the second wedge-shaped member from the first wedge-shaped member.

In order to flow the filler that is filled in the gap between the outer circumference of the rehabilitation pipe and the inner wall surface of the existing pipe, the spacer is provided with an elongated hole for circulating the filler. However, the conventional configuration has a problem that the filler does not sufficiently flow into the spacer and a cavity is generated in the spacer.

The present invention has been made to solve such problems and has an object to provide a spacer for adjusting the position of a rehabilitation pipe and a position adjusting method using the spacer capable of increasing an amount of displacement of the elastic deformable member to easily unlock the first and second wedge-shaped members and also capable of pouring a large amount of a filler into the spacer.

### Means for Solving the Problems

The present invention provides a spacer inserted into a gap between an existing pipe and a rehabilitation pipe to adjust the position of the rehabilitation pipe relative to the existing pipe, comprising:
a first wedge-shaped member that has an inclined surface provided thereon with a plurality of teeth; and
a second wedge-shaped member that has a surface inclined at an angle the same as the inclination angle of the first wedge-shaped member with teeth formed thereon which can engage with the teeth of the first wedge-shaped member, the second wedge-shaped member being overlapped with the first wedge-shaped member so that its teeth engage with the teeth of the first wedge-shaped member so as to allow movement relative to the first wedge-shaped member in the insertion direction increasing the overall height of the spacer but block movement in the opposite direction;
wherein the second wedge-shaped member is provided with a filler passage hole for passing therethrough a filler injected into the gap between the existing pipe and the rehabilitation pipe; and
wherein a portion where the teeth of the second wedge-shaped member are formed is made elastic to provide an elastic deformable member capable of elastically deforming into the filler passage hole such that the teeth of the first and second wedge-shaped members disengage to allow movement of the second wedge-shaped member in the direction opposite the insertion direction.
The present invention also provides a method for adjusting the position of a rehabilitation pipe inside an existing pipe using such a spacer by moving the second wedge-shaped member relative to the first wedge-shaped member in the insertion direction or in the opposite direction.

### Effect of the Invention

According to the present invention, the elastic deformable member can be elastically deformed into the filler passage hole, so that an amount of elastic deformation can be increased and the teeth of the first and second wedge-shaped members can be easily disengaged to allow the second wedge-shaped member to be moved in the opposite direction.

Furthermore, the filler passage hole into which the elastic deformable member deforms and enters extends over the entire width of the second wedge-shaped member, so that a large amount of filler flows into the spacer and cavities formed in the spacer can be minimized.

### BRIEF DESCRIPTION OF DRAWINGS

FIG. 1 is a perspective view showing the structure of a segment used in assembling the rehabilitation pipe;

FIG. 2 is a perspective view showing a state in which segments are linked in the circumferential direction to assemble a pipe unit;

FIG. 3 is a top view showing the segments of the pipe units that are linked in the longitudinal direction using link bolts;

FIG. 4 is an illustrative view showing a state in which the pipe units are linked to install the rehabilitation pipe inside the existing pipe;

FIG. 5 is a cross-sectional view showing a state in which a filler is injected into the gap between the rehabilitation pipe and the existing pipe;

FIG. 6 is a perspective view showing the structure of a first wedge-shaped member that constitutes a spacer for adjusting the position of the rehabilitation pipe;

FIG. 7 is a perspective view showing the lower surface side of a second wedge-shaped member that constitutes the spacer;

FIG. 8 is an illustrative view showing a state in which the second wedge-shaped member is overlapped on the first wedge-shaped member;

FIG. 9 is a cross-sectional view of the wedge-shaped members at the center in the width direction showing that the second wedge-shaped member is moved relative to the first wedge-shaped member;

FIG. 10 is an illustrative view showing a state in which the position of the rehabilitation pipe is adjusted using the spacer;

FIG. 11 is a cross-sectional view showing a process of disengaging the teeth of the first and second wedge-shaped members; and

FIG. 12 is a cross-sectional view showing a state in which the second wedge-shaped member is moved in the direction opposite the insertion direction.

### MODE OF CARRYING OUT THE INVENTION

The present invention will now be described with references to embodiments illustrated in the accompanying drawings. The present invention is suitable for rehabilitating or repairing large-diameter existing pipes such as sewage pipes, water supply pipes, tunnels, agricultural irrigation channels, and the like. In the present embodiment, the rehabilitation pipes are described as having a circular cross-section profile orthogonal to the longitudinal direction. However, it shall be apparent that the present invention can be applied to a rehabilitation pipe having a square or another non-circular cross-section. Also, in addition to structures in which the cross-section profile is closed as a pipe, a structure having a horseshoe-shaped, semi-circular, U-shaped, or another cross-section profile in which one side is open can also be considered to be a pipe, and the present invention can also be applied thereto.

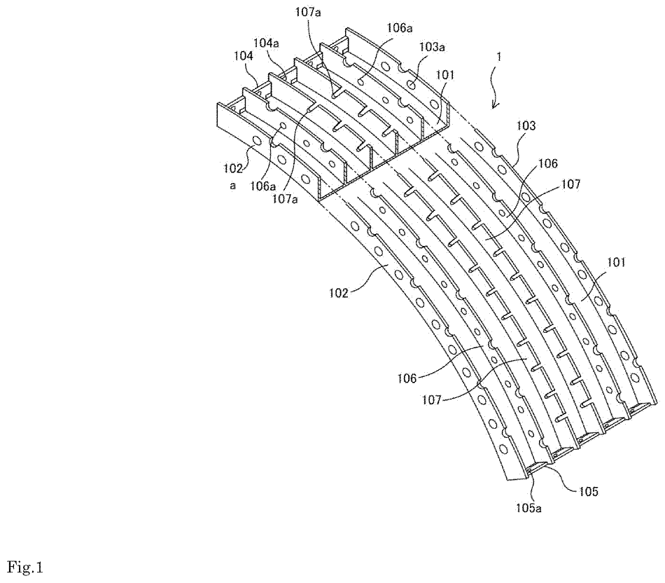

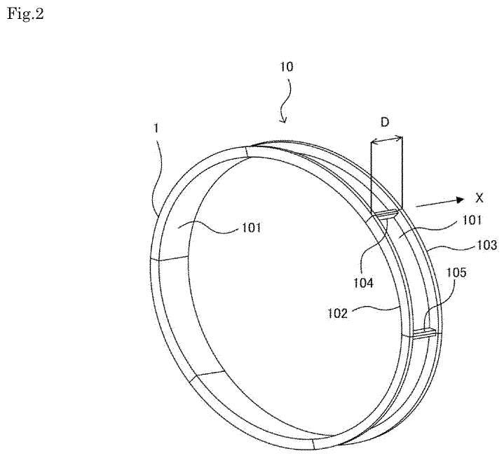

In the present specifications, the longitudinal direction refers to the direction indicated by arrow X extending in the longitudinal direction of a pipe unit 10 in FIG. 2, and the circumferential direction refers to the direction of the circumference of the circle forming the pipe unit 10. FIG. 1 shows the structure of a segment 1 for pipe rehabilitation (hereafter simply referred to as “segment”).

The segment 1 is an integrally formed block-shaped member made from a plastic material, comprising an inner surface plate 101 constituting an inner circumferential surface of the rehabilitation pipe, side plates 102, 103 with the same thickness provided vertically upright on both sides extending in the circumferential direction of the inner surface plate 101, and end plates 104, 105 with the same thickness provided vertically upright on both ends extending in the longitudinal direction of the inner surface plate 101.

In order to reinforce the mechanical strength of the segment 1, a plurality of inner plates 106, 107 having a shape similar to and the same thickness as the side plates 102, 103 are provided upright at equal intervals and parallel thereto on the upper surface of the inner surface plate 101 and on the inside of the side plates 102, 103. The segment 1 has a shape that is curved as an arc representing a predetermined angle that equally divides the circumference, e.g., a 60° arc that divides the circumference into sixths. However, the segment may be shaped as, e.g., a cuboid or a shape that is bent so as to have a curved right angle depending on the cross-section profile or the size of the existing pipe or the location of the existing pipe to be repaired.

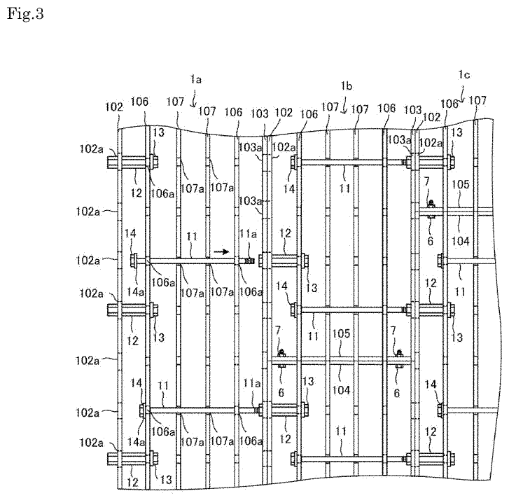

In order to link the segments 1 in the longitudinal direction, a plurality of circular insertion holes 102a, 103a for passing a link bolt 11 and a nut 12 therethrough (FIG. 3) are provided at equal intervals along the circumference on the side plates 102, 103. A plurality of circular insertion holes 106a for passing the link bolt 11 therethrough are also provided at equal intervals on the inner plate 106. A plurality of notches 107a are provided at equal intervals on the inner plate 107 to provide a function as an insertion hole through which the link bolt 11 can pass. The insertion holes 102a, 103a, 106a and the notches 107a are located at coinciding positions along the circumferential direction.

The end plates 104, 105 are disposed between the side plate 102 and the side plate 103. Provided on the end plates 104, 105 are a plurality of circular insertion holes 104a, 105a for passing a linking member such as a link bolt to link the segments 1 in the circumferential direction. The end plate 105 of one segment is aligned in contact with the end plate 104 of the other segment, and a bolt 6 and a nut 7 (FIG. 3) are threadedly engaged to link them in the circumferential direction.

By sequentially linking the segments 1 in the circumferential direction around the full circumference, it is possible to assemble a ring-shaped pipe unit 10 having a predetermined length D in the longitudinal direction X as shown in FIG. 2. The outside diameter of the pipe unit 10 is slightly smaller than the inside diameter of the existing pipe to be rehabilitated. In FIG. 2, the inner surface plate 101, the side plates 102, 103, and the end plates 104, 105, which are the principal structural members of the segment 1, are shown. In order to prevent the drawing from becoming complicated, the reinforcement structures such as the inner plates 106, 107 are not shown.

As shown in FIG. 3, the pipe units 10 are sequentially linked in the longitudinal direction. In FIG. 3, a plurality of metallic nuts 12 are secured to the inner plates 106 of the segments 1a, 1b, 1c of the pipe units using bolts 13. The nut 12 is longer in the longitudinal direction than the interval between the side plate 102 and the inner plate 106, and protrudes from the side plate 102 of the segment so long as to be equal to or greater than the thickness of the side plate 103 of another segment. A link bolt 11 is a columnar elongated bolt, and has at one end a screw part 11a screwed into the nut 12 and at the other end a head 14 with a flange 14a.

When linking the segment 1a of the pipe unit to the segment 1b of the other adjacent pipe unit, the nut 12 protruding from the side plate 102 of the segment 1b is passed through the insertion hole 103a in the side plate 103 of the segment 1a, and the side plates 103, 102 of the segments 1a, 1b are aligned in contact with each other.

The link bolt 11 is then inserted through the insertion hole 102a in the side plate 102, the insertion holes 106a in the inner plates 106 and the notches 107a in the inner plates 107 of the segment 1a, and the screw part 11a thereof is screwed into the nut 12 that is secured to the segment 1b, thereby linking the link bolt 11 to the nut 12. The link bolt 11 is further screwed into the nut 12 until the flange 14a of the head 14 is pressed against the leftmost inner plate 106 of the segment 1a, thereby bolting and linking the segments 1a, 1b in the longitudinal direction.

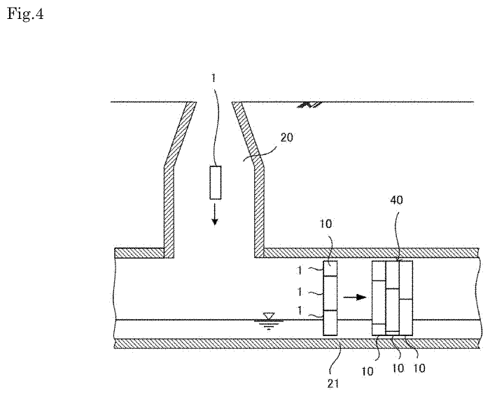

As shown in FIG. 4, the segment 1 is carried through a manhole 20 into an existing pipe 21, and the segments are sequentially linked in the circumferential direction to assemble the pipe unit 10. The segments of the pipe units 10 are then sequentially linked in the longitudinal direction as shown in FIG. 3 to install a rehabilitation pipe 40 in the existing pipe 21. A filler is injected into a gap between the rehabilitation pipe 40 and the existing pipe 21.

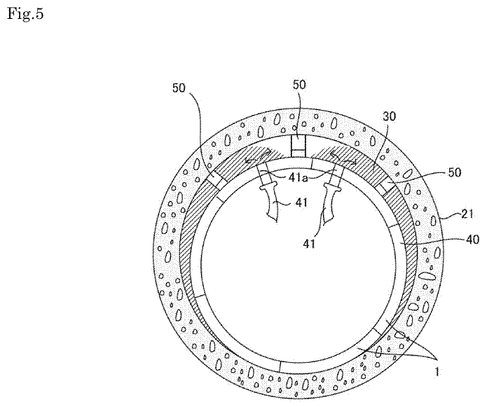

The installed rehabilitation pipe 40 is made of a plastic material and has a low specific gravity and floats on the filler. Therefore, it is necessary to press the rehabilitation pipe downward and adjust its position to a position slightly downward from the position concentric with the existing pipe 21 and to a position in which the lower end of its outer circumference comes in contact with the bottom of the existing pipe 21. For this, in the present embodiment, a spacer 50 as shown in FIG. 5 is inserted for positional adjustment at a plurality of locations between the inner wall surface of the existing pipe 21 and the upper side outer periphery of the rehabilitation pipe 40 every time the pipe units 10 are linked to assemble the rehabilitation pipe 40 to a predetermined length (for example, about 1 m).

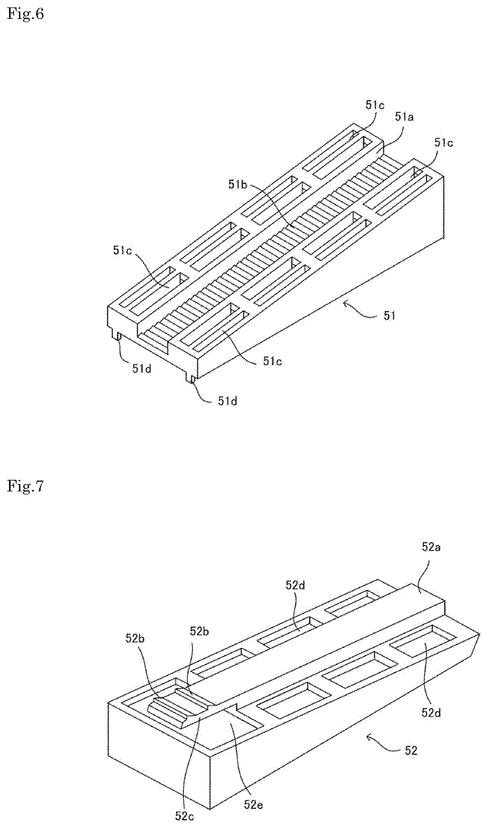

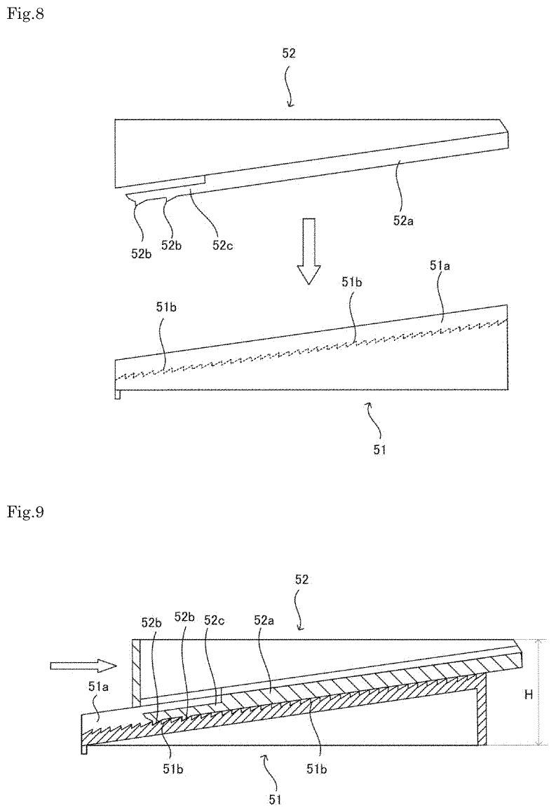

As shown in FIG. 8, the spacer 50 is constructed by vertically overlapping a first plastic wedge-shaped member 51 with its upper side shown in FIG. 6 and a second plastic wedge-shaped member 52 with its lower side shown in FIG. 7.

The first wedge-shaped member 51 has a substantially wedge-shaped outer shape as a whole and is inclined at a predetermined angle (for example, about 10 degrees) so that the upper surface is higher on the far side as viewed in the insertion direction and the lower surface is horizontal with a guide groove 51a having a predetermined width being formed linearly at the central portion as viewed in the width direction along the direction of the inclined line. A plurality of teeth 51b are formed on the bottom surface of the guide groove 51a in a sawtooth shape at a predetermined short pitch of, for example, about several mm.

A plurality of elongated holes 51c (16 holes in the illustrated example) for passing the filler are formed on both sides of the guide groove 51a in the width direction, and feet 51d for locking the wedge-shaped member 51 to the segment 1 are formed at one end of the first wedge-shaped member 51.

The second wedge-shaped member 52 with its lower side shown in FIG. 7 has a substantially wedge-shaped outer shape as a whole and has the same length and width as the first wedge-shaped member 51. The lower surface of the second wedge-shaped member 52 as viewed in FIG. 7 is inclined at the same angle as the upper surface of the first wedge-shaped member 51 and the upper surface thereof as viewed in FIG. 7 is made horizontal.

The second wedge-shaped member 52 has at the center part in the width direction a protruding part 52a that fits into the guide groove 51a of the first wedge-shaped member 51. The protruding part 52a is formed vertically thinner at one end so as to be elastically deformable downward as viewed in FIG. 7. Hereinafter, the portion of the protruding part 52a that is made thinner is referred to as an elastic deformable member 52c.

The elastic deformable member 52c is provided with a plurality of teeth 52b (two teeth in FIG. 7) at integer multiples (for example, about 10 to 20 mm) of the pitch of the teeth 51b of the first wedge-shaped member 51. As shown in FIG. 8, the protruding part 52a of the second wedge-shaped member 52 is fitted into the guide groove 51a of the first wedge-shaped member 51 and both the wedge-shaped members 51 and 52 are aligned in contact at the inclined surfaces thereof. This causes the teeth 52b of the elastic deformable member 52c to engage with the teeth 51b of the guide groove 51a.

The second wedge-shaped member 52 is provided at both sides of the protruding part 52a with a plurality of elongated holes 52d (six holes in the illustrated example) for passing the filler, and also provided at the portion of the elastic deformable member 52c with a filler passage hole 52e. The filler passage hole 52e is larger than the elongated hole 52d and extends over the entire width direction of the second wedge-shaped member 52 so as to be large enough to pass a large amount of filler. As will be described later, the elastic deformable member 52c is made long enough to be capable of elastically deforming inside the filler passage hole 52e without any trouble.

As shown in FIG. 8, the first and second wedge-shaped members 51 and 52 are aligned at the inclined surfaces and the protruding part 52a of the second wedge-shaped member 52 is fitted into the guide groove 51a of the first wedge-shaped member 51. When thus fitted, the teeth 52b of the second wedge-shaped member 52 engage with any of the teeth 51b of the first wedge-shaped member 51, and the surfaces of the wedge-shaped members 51 and 52 opposite the inclined surfaces become parallel to each other.

The second wedge-shaped member 52 is pressed in the insertion direction as shown by an arrow in FIG. 9. The teeth 51b and 52b are inclined in the same direction at one side at which they engage, so that the second wedge-shaped member 52 can be moved in the insertion direction and the overall height H of the spacer 50 can be increased for adjustment to a desired height. On the other hand, when the second wedge-shaped member 52 is pulled in the opposite direction, the reverse movement of the second wedge-shaped member 52 is prevented because the teeth 51b and 52b are substantially vertical at the other side at which they engage.

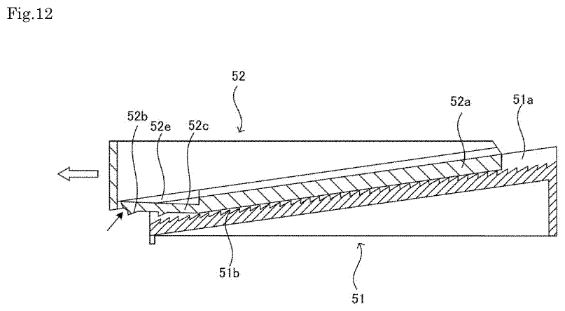

A tool or a finger is inserted in the direction indicated by the arrow in a state in which the teeth 51b and 52b of the first and second wedge-shaped members 51 and 52 engage with each other as shown in the upper part of FIG. 11. Subsequently, the elastic deformable member 52c is, as shown in the lower part of FIG. 11, lifted by the tool or the finger to elastically deform the elastic deformable member 52c into the filler passage hole 52e and disengage the teeth 51b and 52b. When thus disengaged, the second wedge-shaped member 52 can be moved in the arrow direction as shown in FIG. 12, allowing the overall height of the spacer to be adjusted so as to be lower. The elastic deformable member 52c has an inclined surface at the distal end so that the tool or the finger can be easily inserted.

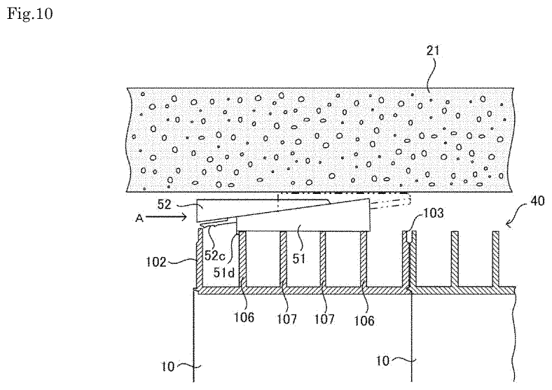

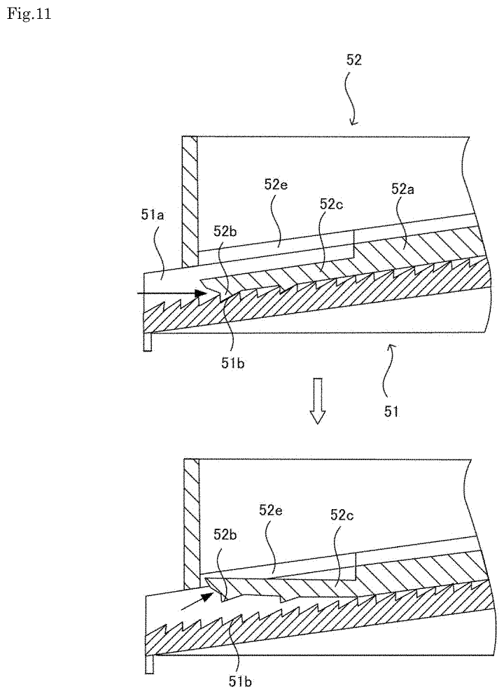

In such a configuration, the position of the rehabilitation pipe 40 is adjusted using the spacer 50. In a state in which the first and second wedge-shaped members 51, 52 are overlapped, the spacer 50 is inserted into the gap between the existing pipe 21 and the rehabilitation pipe 40. As shown in FIG. 10, the feet 51d of the first wedge-shaped member 51 are engaged with the inner plate 106 of the segment 1 to fix the first wedge-shaped member 51 thereto.

Subsequently, the second wedge-shaped member 52 is pressed and moved in the insertion direction indicated by the arrow A to sequentially increase and adjust the overall height of the spacer stepwise to a desired height corresponding to the gap between the existing pipe 21 and the rehabilitation pipe 40.

In a case in which the overall height of the spacer is too high, the elastic deformable member 52c is, as shown in FIG. 11, lifted with the tool or the like and elastically deformed into the filler passage hole 52e to disengage the teeth 51b and 52b. This allows the second wedge-shaped member 52 to be moved in the opposite direction, as shown in FIG. 12, making it possible to adjust the overall height of the spacer so as to be low.

In this embodiment, the portion of the second wedge-shaped member 52 where the teeth 52b thereof engage with the teeth 51b of the first wedge-shaped member 51 is made elastic to provide the elastic deformable member 52c capable of elastically deforming into the filler passage hole 52e. This enables the amount of elastic deformation of the elastic deformable member 52c to increase and the teeth 51b and 52b to disengage with ease, making it possible to easily move the second wedge-shaped member 52 in the opposite direction.

In this way, the second wedge-shaped member 52 is moved relative to the first wedge-shaped member 51 in the insertion direction or the opposite direction to adjust the position of the rehabilitation pipe 40. The second wedge-shaped member is repeatedly moved relative to the first wedged-shaped member in the insertion or reverse direction until the spacer reaches a desired height. When thus adjusted to the desired height, the filler 30 is, as shown in FIG. 5, injected into the gap between the inner wall surface of the existing pipe 21 and the outer periphery of the rehabilitation pipe 40 and into the space outside the inner surface plate 101 of the segment 1. A hole 41a is formed at an appropriate position of the segment 1 and an injection hose 41 is connected thereto to inject the filler 30.

The first wedge-shaped member 51 and the second wedge-shaped member 52 are provided with the elongated holes 51c and 52d, allowing the filler 30 to flow into the spacer 50, so that no cavities are created in the spacer 50.

Furthermore, the filler passage hole 52e into which the elastic deformable member 52c deforms and enters extends over the entire width direction in the second wedge-shaped member 52, so that a large amount of the filler 30 flows into the spacer 50, allowing the cavity formed in the spacer to be minimized.

Although the pitch of the teeth 51b of the first wedge-shaped member 51 is different from that of the teeth 52b of the second wedge-shaped member 52, both the pitches of the teeth 51b, 52b can be made same.

It is of course that the present invention can be widely applied not only to the positional adjustment of the rehabilitated pipe in the existing pipe rehabilitation work, but also to the positional adjustment performed by inserting the spacer into the gap between a fixed object and an object to be adjusted positionally.

### KEY TO THE SYMBOLS

1 segment
10 pipe unit
21 existing pipe
40 rehabilitation pipe
50 spacer
51 first wedge-shaped member
51a guide groove
51b teeth
52 second wedge-shaped member
52a protruding part
52b teeth
52c elastic deformable member
52e filler passage hole

1. A spacer inserted into a gap between an existing pipe and a rehabilitation pipe to adjust the position of the rehabilitation pipe relative to the existing pipe, comprising:
a first wedge-shaped member that has an inclined surface provided thereon with a plurality of teeth; and
a second wedge-shaped member that has a surface inclined at an angle the same as the inclination angle of the first wedge-shaped member with teeth formed thereon which can engage with the teeth of the first wedge-shaped member, the second wedge-shaped member being overlapped with the first wedge-shaped member so that its teeth engage with the teeth of the first wedge-shaped member so as to allow movement relative to the first wedge-shaped member in the insertion direction increasing the overall height of the spacer but block movement in the opposite direction;
wherein the second wedge-shaped member is provided with a filler passage hole for passing therethrough a filler injected into the gap between the existing pipe and the rehabilitation pipe; and
wherein a portion where the teeth of the second wedge-shaped member are formed is made elastic to provide an elastic deformable member capable of elastically deforming into the filler passage hole such that the teeth of the first and second wedge-shaped members disengage to allow movement of the second wedge-shaped member in the direction opposite the insertion direction.

2. A spacer according to claim 1, wherein the filler passage hole extends over the entire width of the second wedge-shaped member.

3. A spacer according to claim 1, wherein the teeth of the first and second wedge-shaped members are formed at the same or different pitches.

4. A method for adjusting the position of a rehabilitation pipe inside an existing pipe using a spacer according to claim 1, comprising:
overlapping the first and second wedge-shaped members for insertion in the gap between the existing pipe and the rehabilitation pipe;
pressing the second wedge-shaped member in the insertion direction to move it relative to the first wedge-shaped member to stepwise increase the overall height of the spacer; and
elastically deforming the elastic deformable member into the filler passage hole to disengage the teeth of the first and second wedge-shaped members and move the second wedge-shaped member in the direction opposite the insertion direction.

5. A method according to claim 4, wherein the second wedge-shaped member is repeatedly moved relative to the first wedged-shaped member in the insertion or reverse direction until the spacer reaches a desired height.
